(19) United States
(12) Patent Application Publication
(10) Pub. No.: US 2008/0025345 A1
(43) Pub. Date: Jan. 31, 2008

(54) Methods and Systems for Buffer Management

(76) Inventor: Daniel J. Park, Beaverton, OR (US)

Correspondence Address: KRIEGER INTELLECTUAL PROPERTY, INC., P.O. BOX 1073, CAMAS, WA, 98607, US

(21) Appl. No.: 11/460,527

(22) Filed: Jul. 27, 2006

(51) Int. Cl. H04J 3/06

(52) U.S. Cl. 370/503; 370/412

(57) ABSTRACT

Embodiments of the present invention comprise systems, methods and devices for buffer management in which the error in the local clock may be estimated based on synchronization corrections.

### FIELD OF THE INVENTION

Embodiments of the present invention comprise methods and systems for buffer management at timebase discontinuities.

### BACKGROUND

Delays, in addition to those due to network jitter, may be required and introduced in the rendering of digitally encoded audio-video (AV) programming transmitted over a packet-based network at the transition point between AV sources with different AV source clocks to compensate for source clock mismatch. Such a transition point may occur when a user switches from one AV program, for example, one satellite MPEG channel, to another AV program, for example, another satellite MPEG channel. AV data accumulated in the playout buffer from the previous source may be displayed until the new source material is available at the output of the playout buffer, thereby producing an undesirable delay between when the user changes the channel and when the content of the new channel is displayed. It is desirable to minimize such delays.

### SUMMARY

Embodiments of the present invention comprise systems and methods for buffer management comprising estimating a range of error for a local clock based on correction values obtained at timebase discontinuities.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 depicts a encoder/decoder system in which the source clock and the local may be synchronized (prior art);

FIG. 2 is a diagram showing an exemplary playout buffer;

FIG. 3 is a diagram showing embodiments of the present invention in which an error in clock frequency may be estimated;

FIG. 4 is a diagram showing embodiments of the present invention in which an error in clock frequency may be estimated; and

FIG. 5 is a diagram showing embodiments of the present invention in which buffer management may be based on discarding the tail end AV data at a timebase discontinuity.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

In a packet-based network, such as a local area network (LAN) or the Internet, where a sending device is transmitting an encoded audio-video (AV) source stream to a receiving device across the network for display, the receiving device may need to remove any jitter introduced by the network transport. The receiving device may also need to synchronize a local AV display clock to the source AV clock so that the source material may be rendered without overflowing or under-flowing a playout buffer at the receiving device. The playout buffer may overflow if the local clock (the clock at the receiving device) rate is less than the rate of the source clock (the clock at the sending device). Underflow may occur when the local clock is running fast relative to the source clock, that is, the local clock rate is greater than that of the source clock. The receiving device may extract timing information from the AV data stream in order to synchronize the local AV display clock and the source AV clock for the purposes of preventing buffer overflow and buffer underflow.

For example, in an MPEG2 system, the transport stream consists of packets which may contain clock synchronization information in fields called the Program Reference clock (PCR) and System Clock Reference (SCR). Synchronization between the transmitter (also considered the encoder, sending device or transmitting device) and receiver (also considered the decoder or receiving device) during data transmission is essential to assure that overflow and underflow do not occur at the receiver.

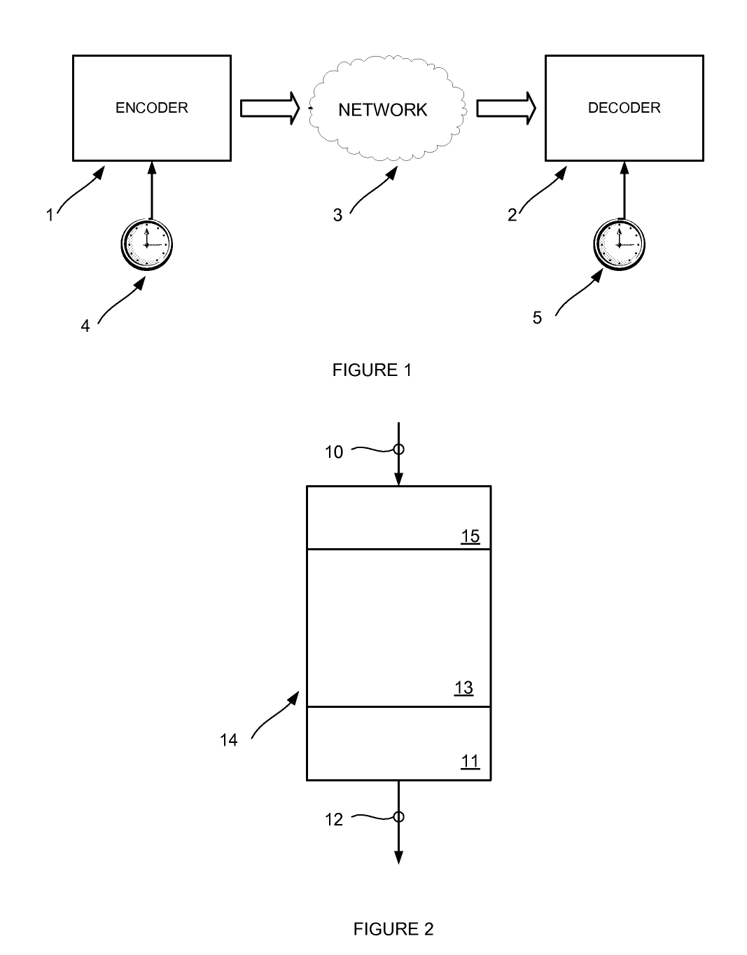

FIG. 1 depicts a typical encoder/decoder system. At the encoder 1, the source clock 4 may be inserted into the stream, the stream may then be transmitted through the network 3, and at the decoder 2, the source clock may be reconstructed at the local clock 5 by slewing the free-running local clock frequency to match the source clock's frequency. The free-running clock frequency of both the source clock and the local clock are assumed to be 27 MHz±30 parts per million (PPM) in an MPEG2 system. Therefore, there is a potential difference between the source clock frequency and the free-running clock frequency of ±60 PPM. A phase-locked loop is typically used to correct the local clock rate to match that of the transmitter, which is assumed to be within ±30 PPM of absolute 27 MHz.

The size of the buffer used for de-jittering must be sufficient to compensate not only for the jittering of the encoded AV packets by the network, but also for the AV data required to cover the periods when the local AV clock frequency is not the same as the source AV clock frequency. Such periods (also considered clock recovery periods) may arise when a transition occurs between AV sources with different AV source clocks. One example of such a transition point occurs when a user switches from one AV program, for example, one satellite MPEG channel, to another AV program, for example, another satellite MPEG channel. AV data accumulated in the playout buffer from the previous source may be displayed until the new AV material from the new source is available at the output of the playout buffer, thereby producing an undesirable delay between when the user changes the channel and when the content of the new channel is displayed. The buffer space required for dejittering, including clock recovery, may make up a significant portion of the playout buffer. The more AV data that is placed into the playout buffer, the greater the delay from the reception of the AV data at the receiver to the display of the AV data.

For a system where the difference between the source clock rate and the absolute clock rate is ±Δ PPM, and the difference between local clock rate and the absolute clock rate is ±Δ PPM, the amount of buffer space required during clock recovery to prevent underflow or overflow must be sufficient to accommodate data for the worst-case fast or worst-case slow local clock, +2Δ PPM, respectively. The free-running frequency of a worst-case fast local clock is +2Δ PPM with respect to the source clock frequency. The free-running frequency of a worst-case slow local clock is −2Δ PPM with respect to that of the source clock.

FIG. 2 depicts an exemplary buffer 14 into which incoming AV data 10 may be buffered before being removed and sent 12 to the decoder for display. In some embodiments of the present invention, the lower section 11 of the buffer 14, also considered the clock-fast portion, may be large enough to store sufficient data so that the buffer 14 will not underflow during clock recovery when the local clock frequency is greater, also considered faster, than the source clock frequency. The middle portion 13 of the buffer 14 may be large enough to store sufficient data to account for network jitter, and the top portion 15, also considered the clock-slow portion, of the buffer 14 may be large enough to accommodate arriving data without overflowing during clock recovery when the clock frequency of the source is faster than the local clock frequency.

Since the true frequency of the source clock and the free-running frequency of the local clock are not known within the range of ±Δ PPM of the absolute clock, the buffer portions 11 and 15 may be large enough to account for the worst-case fast and the worst-case slow clock differences, respectively. For example, in an MPEG2 system, the clocks are accurate to within ±30 parts per million (PPM) with respect to a absolute frequency of 27 MHz. Therefore the local clock may be 60 PPM faster than the source clock, and the buffer region 11, which mitigates underflow, may be large enough to account for this difference in clock frequency. The local clock may be 60 PPM slower than the source clock, and the buffer region 15, which mitigates overflow, may be large enough to account for this difference in clock frequency. Some embodiments of the present invention may reduce latency by reducing the size of buffer required to compensate for overflow and underflow. Some embodiments of the present invention may reduce the size of the buffer required to compensate for overflow and underflow by estimating the free-running local clock frequency.

In some embodiments of the present invention, the source clock rate is assumed within a known frequency range, and the frequency of the local clock may be locked, or tracked, to that of the source clock. If the maximum and minimum deviations from an absolute clock rate of the source and local clock are known, then when a correction is made at the local clock, the range in which the free-running local clock frequency is known to exist, may be tighten. For illustration, if the free-running source clock frequency and the free-running local clock frequency are each known to be within ±Δ PPM of an absolute frequency, F_{abs}, and a correction of +δ₁ PPM is applied to the local clock to lock it to the source clock, then the free-running local clock frequency error to F_{abs} is known to be less than (Δ−δ₁) PPM, referred to as the estimated maximum error (estMaxErr). If a correction of −δ₂ PPM is applied to the local clock to lock it to the source clock, then the free-running local clock frequency is known to be greater than (−Δ+δ₂) PPM, referred to as the estimated minimum error (estMinErr). Given a new a bound on the error in the free-running local clock frequency, the worse-case fast or the worst-case slow buffer requirements may be adjusted.

The amount of buffer required to assure that there is no underflow of the buffer may be reduced from that corresponding to an initial rate difference of 2Δ PPM to that corresponding to a rate difference of (Δ+(estMaxErr−estMinErr)) PPM. In some embodiments of the present invention, the error bounds (estMinErr and estMaxErr) on the free-running local clock frequency may be updated, if appropriate, at each timebase discontinuity.

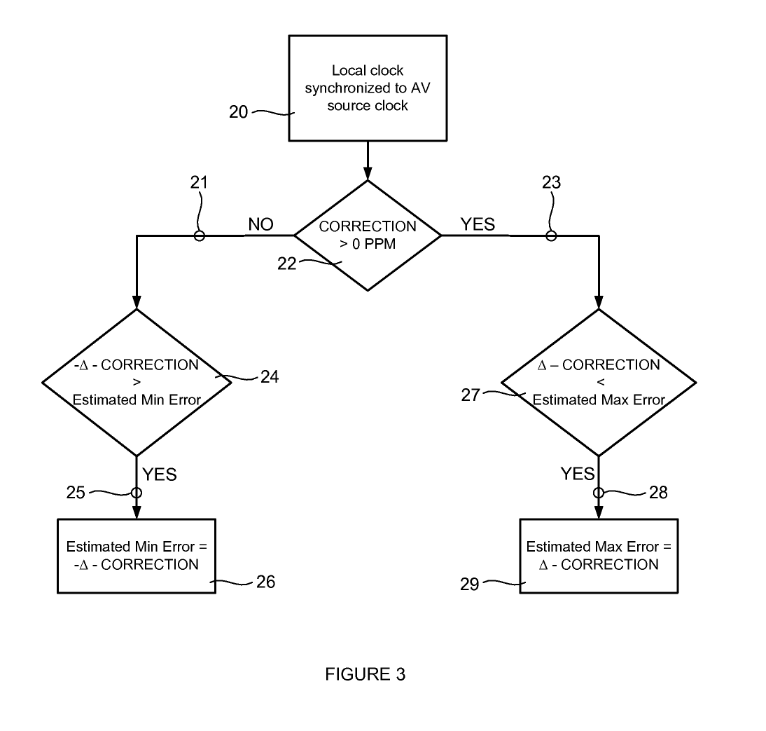

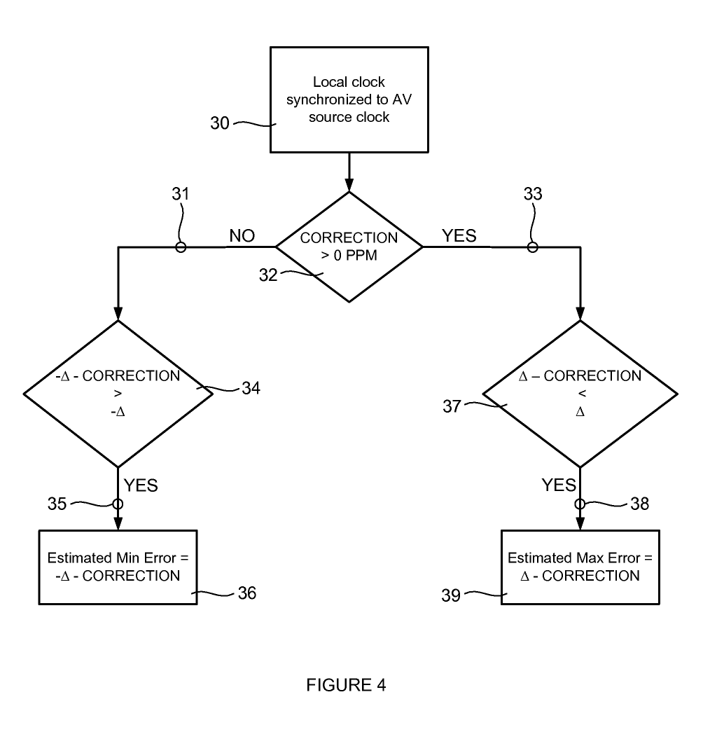

FIG. 3 shows embodiments of the present invention in which the estimated error range of the local clock frequency is updated after the local clock synchronizes with the source clock 20. The correction value required to lock the local clock to the source clock may be examined 22. If the correction value is less than zero 21 (that is, if the local clock was faster than source clock and therefore must have been slowed down), then the minimum frequency bound guaranteed by this correction may be checked against the current minimum 24, and if the new bound is greater than the old bound 25, the bound may be updated 26. If the correction value is greater than zero 23 (that is, if the local clock was slower than source clock and therefore must have been sped up), then the maximum frequency bound guaranteed by this correction may be checked against the current maximum 27, and if the new bound is less than the old bound 28, the bound may be updated 29. The free-running local clock frequency is known to be ±Δ PPM of an absolute frequency from the manufacturer. Embodiments of the present invention shown in FIG. 3 may tighten these known bounds. An initial adjustment of the bounds may be made with respect to ±Δ PPM, as shown in FIG. 4.

FIG. 4 shows embodiments of the present invention in which the estimated error range of the local clock frequency is initially updated after the local clock synchronizes with the source clock 30. The correction value required to lock the local clock to the source clock may be examined 32. If the correction value is less than zero 31 (that is, if the local clock was faster than source clock and therefore must have been slowed down), then the minimum frequency bound guaranteed by this correction may be checked against the manufacturer minimum, −Δ PPM, 34, and if the new bound is greater than the old bound 35, the bound may be updated 36. If the correction value is greater than zero 33 (that is, if the local clock was slower than source clock and therefore must have been sped up), then the maximum frequency bound guaranteed by this correction may be checked against the current maximum 37, and if the new bound is less than the old bound 38, the bound may be updated 39.

Some embodiments of the present invention may reduce the delay in the rendering of digitally encoded real-time AV programming at the point where a transition occurs between AV sources with different AV source clocks by minimizing the amount of real-time AV data in the playout buffer at the transition. In some embodiments, the encoding may be MPEG encoding. In these embodiments, the discontinuity of an MPEG video source and its MPEG source clock may be indicated in the MPEG data steam by the discontinuity indicator included in the MPEG packet header.

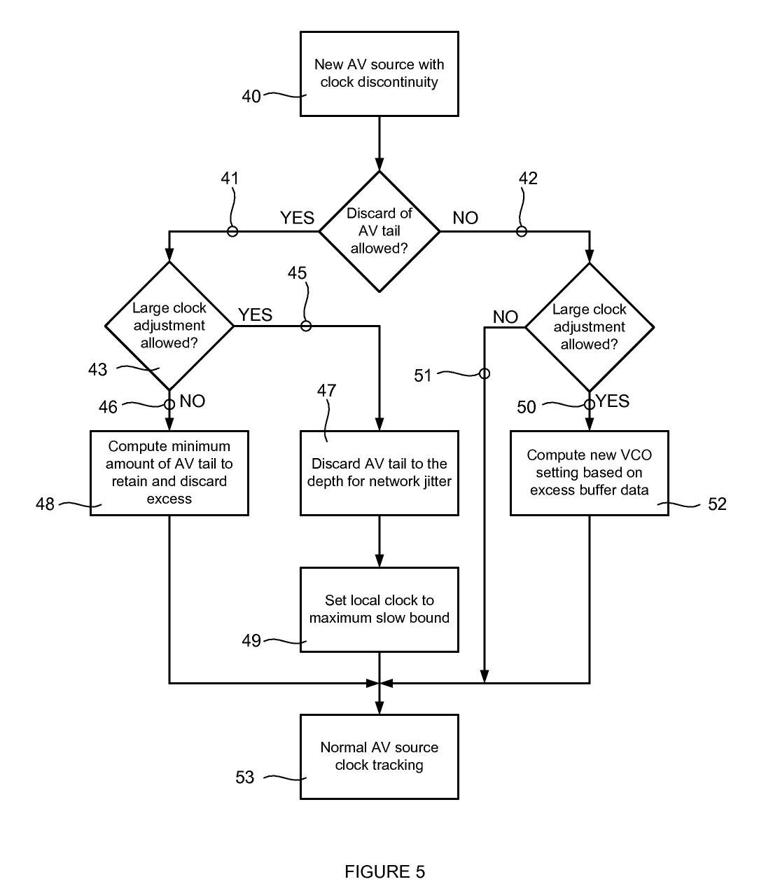

FIG. 5 shows embodiments of the present invention in which the local variable oscillator correction value may be determined when a new AV stream with a new AV source clock frequency is received at a receiving device 40. In some embodiments of the present invention, the receiving device may be permitted to discard the tail end of the previous AV stream 41. As an example, when the channel is changed in a digital television, the source remaining in the playout buffer may be discarded without disrupting the viewing experience since it is, after all, the viewer that requested the transition, and in fact, it is likely that any latency involved in playing out any remaining source from the previous channel is more disruptive to the viewer.

In embodiments of the present invention in which the tail end of the previous AV stream may be discarded 41, the amount of discard may be determined based on whether or not large clock adjustments are permitted 43. If large clock adjustments are allowed 45, the tail end of the previous AV stream may be discarded so that only sufficient data may remain in the buffer to cover network jitter 47. The local clock frequency may then be corrected to a frequency that accounts for a maximally slow source clock and the worst-case slow condition of the free-running local clock 49. Normal AV source clock tracking may then resume 53. This adjustment to the local clock may guarantee that underflow does not occur since the local clock frequency is less than the source clock frequency. The correction (oscCorr) may be given by: oscCorr=−Δ−estMaxErr. Underflow may not occur because the local clock is guaranteed to be slower than the source clock, and the buffer has only enough data to account for network jitter, therefore the latency may be minimized.

In some embodiments of the present invention, it may be permissible to discard the tail end of the previous AV stream 41, but a large adjust of the local clock frequency may not be allowed 46. In these embodiments, the amount data to be retained in the buffer to account for network jitter and to compensate for a worst-case difference between the new AV source clock frequency and a worst-case local clock error may be calculated 48, and any excess data may be discarded 48. In some embodiments, the calculating function, by which the minimum amount of AV tail to retain may be calculated, may be a function of the characteristics of the tracking method. In some embodiments, the tracking method may be a phase-locked loop, and the calculating function may be a linear function. In some embodiments, the function may be implemented as a look-up-table. After discarding excess buffer data, normal AV source clock tracking may resume 53.

In some embodiments of the present invention, it may be prohibited to discard the tail end of the previous AV stream 42, but a large adjustment of the local clock may be permitted 50. The local clock rate may then be corrected to a frequency so that, given the current amount of data in the buffer, the data is sufficient to cover a worst-case fast local clock and network jitter during the time anticipated to correct for the new clock 52. The correction may be determined by a correction function which calculates the local clock frequency required to consume excess buffer data. In some embodiments, the correction function may be a function of the tracking method. In some embodiments, the tracking method may be a phase-locked loop, and the calculating function may be a linear function. In some embodiments, the function may be implemented as a look-up-table. Normal AV source clock tracking may then resume 53 after the local clock has been adjusted to consume the excess buffer data.

If it is not permissible to discard the tail end of the previous AV stream 42 and large clock adjustments are not allowed 51, then normal AV source clock tracking 53 may be performed in embodiments of the present invention.

In some embodiments of the present invention, source clock tracking may be accomplished using a phase-locked loop. Alternates to a phase-locked loop include a Kalman filter, a least-square linear regression algorithm, a Wiener filter for tracking, and other prediction-correction control methods known in the art.

For the purposes of this specification and the associated claims and drawings, the term AV data may refer to audio data, video data or both audio and video data.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A method for buffer management in an audio-video (AV) decoder, said method comprising:
a) receiving a source AV stream at an AV decoder, wherein said source AV stream comprises a source clock comprising a source clock error range and said AV decoder comprises a local clock and a buffer, wherein said local clock has a local clock error range;
b) determining a local clock correction required to synchronize said source clock and said local clock; and
c) adjusting said buffer size based on said local clock correction.

2. A method as described in claim 1 further comprising:
a) receiving a subsequent source AV stream at said AV decoder, wherein said subsequent source AV stream comprises an associated source clock, wherein said associated source clock has an associated source clock error range;
b) determining a subsequent local clock correction required to sychronize said associated source clock and said local clock; and
c) adjusting said buffer size based on said local clock correction and said subsequent local clock correction.

3. A method as described in claim 1 wherein said determining comprises one of a group consisting of a phase-locked loop, a Kalman filter, a Wiener filter and a least-square linear regression method.

4. A method as described in claim 1 further comprising adjusting said local clock error range based on said local clock correction.

5. A method as described in claim 1 wherein said local clock error range and said source clock error range are equal.

6. A method as described in claim 1 wherein said source AV stream is an MPEG bitstream.

7. A method for buffer management in an audio-video (AV) decoder, said method comprising:
a) receiving a source AV stream at an AV decoder, wherein said source AV stream comprises a source clock and said AV decoder comprises a local clock and a buffer, wherein said buffer comprises sufficient data space to account for network jitter and a worst-case fast local clock frequency;
b) removing an amount of AV data from said buffer, wherein said amount of AV data is based on said worst-case fast local clock frequency; and
c) adjusting the clock frequency of said local clock by an adjustment sufficient to guarantee the clock frequency of said local clock is less than the clock frequency of said source clock.

8. A method as described in claim 7 wherein said adjusting comprises an estimate of an error in said local clock.

9. A method as described in claim 8 wherein said estimate is refined at a plurality of timebase discontinuities.

10. A method as described in claim 8 wherein said estimate is based on a local clock correction required to synchronize said source clock and said local clock.

11. A method as described in claim 10 wherein said estimate is refined at a plurality of timebase discontinuities

12. A method as described in claim 10 wherein said local clock correction is, at least partially, determined, by one of a group consisting of a phase-locked loop, a Kalman filter, a Wiener filter and a least-square linear regression method.

13. A method as described in claim 7 wherein said source AV stream is an MPEG bitstream.

14. A method for buffer management in an audio-video (AV) decoder, said method comprising:
a) receiving a source AV stream at an AV decoder, wherein said source AV stream comprises a source clock and said AV decoder comprises a local clock and a buffer; and
b) removing an amount of AV data from said buffer so as to leave remaining in said buffer a remaining amount of AV data, wherein said remaining amount of AV data is sufficient to account for network jitter and a worst-case difference between the frequency of said source clock and a worst-case local clock error, wherein said worst-case local clock error comprises an estimate of an error in said local clock.

15. A method as described in claim 14 wherein said estimate of said error in said local clock comprises determining a local clock correction required to synchronize said source clock and said local clock.

16. A method as described in claim 15 wherein said determining comprises one of a group consisting of a phase-locked loop, a Kalman filter, a Wiener filter and a least-square linear regression method.

17. A method as described in claim 16 wherein said estimate is refined at a plurality of timebase discontinuities.

18. A method as described in claim 14 wherein said estimate is refined at a plurality of timebase discontinuities.

19. A method as described in claim 14 wherein said source AV stream is an MPEG bitstream.

20. A method as described in claim 17 wherein said source AV stream is an MPEG bitstream.
